(19) United States
(12) Patent Application Publication
(10) Pub. No.: US 2003/0222103 A1
(43) Pub. Date: Dec. 4, 2003

(54) Sprayer cap guard

(76) Inventor: Craig R. Sawicki, Elk Grove Village, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/435,884

(22) Filed: May 12, 2003

Related U.S. Application Data
(60) Provisional application No. 60/385,175, filed on May 31, 2002.

(51) Int. Cl. B67D 5/06

(52) U.S. Cl. 222/182

(57) ABSTRACT

A packaging guard for a screw top container includes a screw cap closing the screw top container and having a collar lip with an outside diameter v extending from a bottom portion of an exterior of the screw cap; a cap guard with an inside diameter s greater than the outside diameter v of the collar lip and having an interior lip with an inside diameter w less than the outside diameter v of the collar lip; and wherein the interior lip of the cap guard engages the collar lip when the cap guard is placed substantially over the screw cap, thereby securing the cap guard in a position over the screw cap in which the exterior of the screw cap is substantially covered. The cap guard prevents the screw top from being unscrewed from the container.

### TECHNICAL FIELD OF THE INVENTION

This invention generally relates to product packaging and, more particularly, to a guard for spray bottles.

### DESCRIPTION OF THE RELATED ART

Traditional spray bottles are composed of two sections: a bottle and a mechanical pump or trigger sprayer mechanism. The bottle stores the product while the mechanical pump or trigger sprayer mechanism expels the product from the bottle as a mist. The mechanical pump or trigger sprayer mechanism usually includes a tube that extends down into the bottle, a pump or trigger, an outlet, and a collar. The pump mechanism is normally attached to the bottle by the collar. One common attachment method is to provide mating screw threads on the inside of the collar and on the outside surface of the top end of the bottle, thereby allowing the user to screw the collar, and with it the entire pump mechanism, on and off the bottle.

Spray bottles of this common design are employed to hold and dispense an immense variety of primarily liquid products, including anything from water to household cleaners. Spray bottles may be used by product manufacturers for product packaging or sold as a separate item, in which case the purchaser may fill the bottle with a substance of their choosing.

In the case of spray bottles being used as product packaging, it is possible that a manufacturer may fill bottles with a product that presents some possibility of harm if it is ingested. Many such substances may only present a risk if a user removes the spray mechanism and drinks the contents directly from the bottle. For example, the United States Consumer Product Safety Commission (the “CPSC”) has recently identified products that contain significant amounts of petroleum distillates or other similar hydrocarbon solvents as one such substance. These substances may pose a potential hazard to children if they are directly aspirated into the lungs or aspirated during vomiting. Manufacturers of these hydrocarbon containing products may desire to package their products in spray bottles in the future. If so, these manufacturers must meet the requirements of a recently enacted CPSC regulation, 16 C.F.R. 1700.14(a)(31)(i), that requires that the spray mechanism of a spray bottle either be permanently attached to the bottle portion or be attached with a device. The purpose of this requirement is to minimize the chances that a young child may be able to remove the spray mechanism from the bottle and drink the contents.

Providing a device to prevent a young child from removing the spray mechanism, or at the very least, under extreme conditions, minimizing the chances of a young child carrying out such disconnection may be desirable in many circumstances. However, no such suitable device, that is not permanent, has been available to date.

The present invention is directed to overcoming one or more of the problems set forth above.

### SUMMARY OF THE INVENTION

An aspect of the present invention is to provide a spray bottle having a device for preventing a young child from disconnecting the spray mechanism from the spray bottle, or at the very least, under extreme conditions, minimizing the chances of a young child carrying out such disconnection.

Another aspect of the present invention is to provide an apparatus to prevent the refilling of containers having screw top openings.

In accordance with the above aspect of the invention, there is provided a packaging guard for a screw top container that includes a screw cap closing the screw top container and having a collar lip with an outside diameter v extending from a bottom portion of an exterior of the screw cap; a cap guard with an inside diameter s greater than the outside diameter v of the collar lip and having an interior lip with an inside diameter w less than the outside diameter v of the collar lip; and wherein the interior lip of the cap guard engages the collar lip when the cap guard is placed substantially over the screw cap, thereby securing the cap guard in a position over the screw cap in which the exterior of the screw cap is substantially covered.

These aspects are merely an illustrative aspect of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is an exploded front view of a spray bottle incorporating a sprayer cap guard to prevent a young child from unscrewing the sprayer mechanism from the bottle, or at the very least, under extreme conditions, minimizing the chances of a young child carrying out such disconnection according to the present invention;

FIG. 2 is a front view of a spray bottle incorporating a sprayer cap guard according to the present invention;

FIG. 3 is a partial front view of a spray mechanism for a spray bottle;

FIG. 4 is a top view of the spray mechanism shown in FIG. 3;

FIG. 5 is a partial cross-section view of a spray mechanism incorporating a sprayer cap guard according to the present invention; and

FIG. 6 is a cross-section view of a sprayer cap guard according to the present invention.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

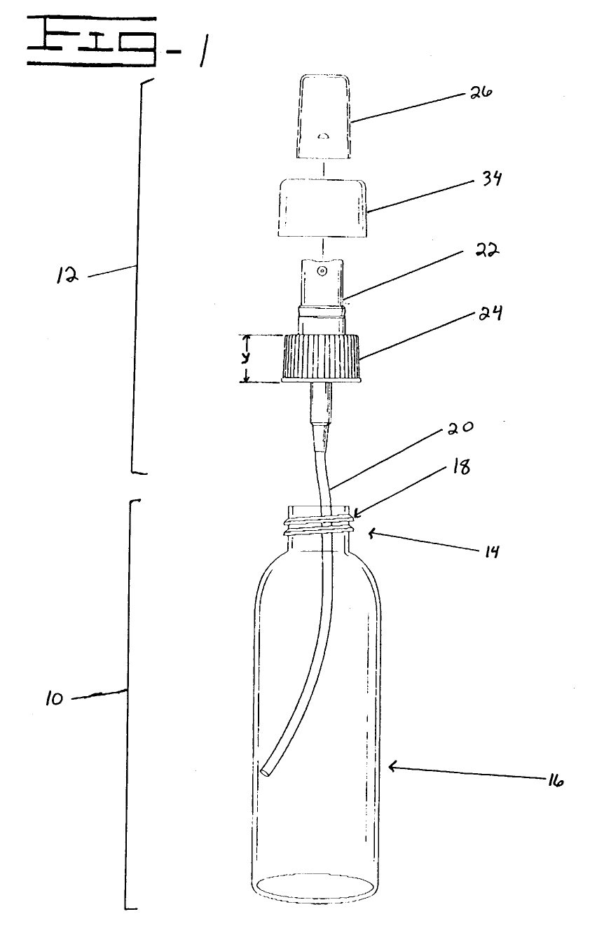

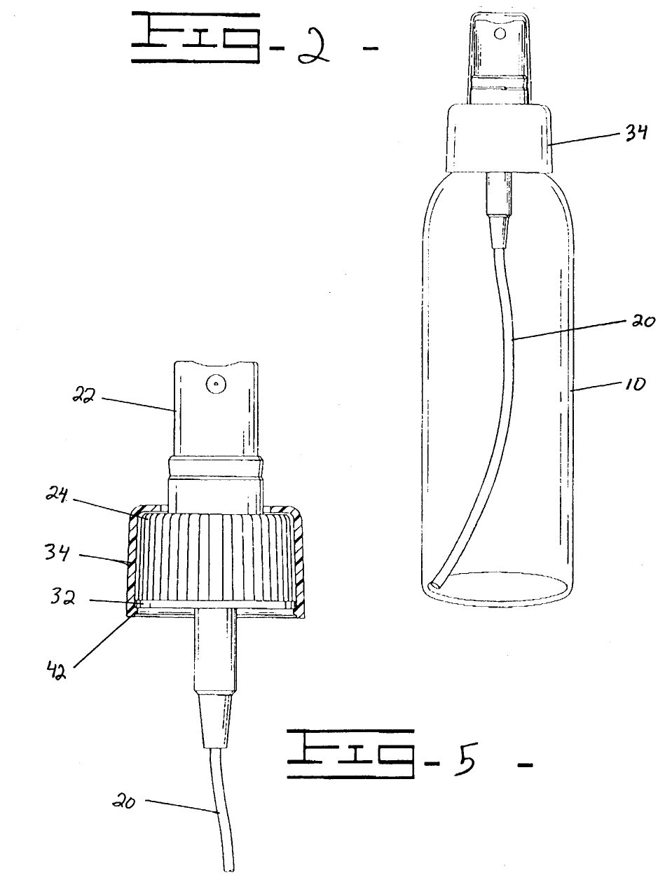

Referring now to the drawings, FIGS. 1 and 2 illustrate a spray bottle incorporating a sprayer cap guard for preventing a young child from unscrewing a spray mechanism 12 from a bottle portion 10 of the spray bottle, or at the very least, under extreme conditions, minimizing the chances of a young child carrying out such disconnection. The bottle itself comprises the bottle portion 10 and the spray mechanism 12. The bottle portion 10 includes a tapered end 14 and a base end 16. The tapered end 14 of the bottle portion 10 includes screw threads 18. The spray mechanism 12 includes a down tube 20, a pump 22, a collar 24, and a cap 26.

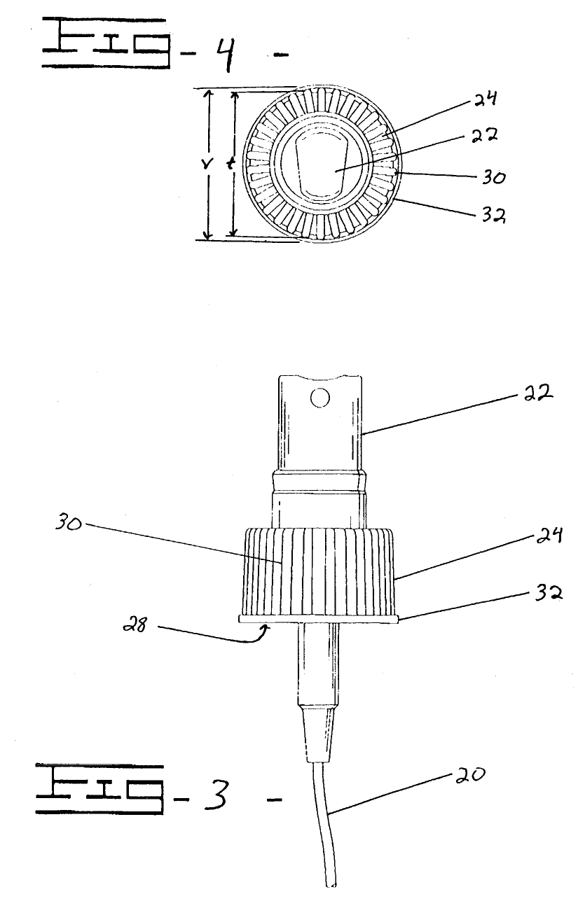

FIGS. 3 and 4 illustrate the spray mechanism 12 in greater detail. The collar 24 has an open end 28 from which emanates the bottom of the pump 22 and the down tube 22 and allows the collar 24 to pass over the tapered end 14 of the bottle portion 10. The outside of the collar 24 is provided with ribs 30 around its periphery to assist the user in rotating the collar 24 when screwing the spray mechanism 12 on to or off of the bottle portion 10. The interior surface of the collar 24 has screw threads (not shown). The screw threads of the collar 24 are intended to mate with the screw threads 18 of the tapered end 14 of the bottle portion 10 to form the connection between the bottle portion 10 and the spray mechanism 12. The open end 28 of the collar 24 is provided with a collar lip 32 that possesses a greater diameter v than the remainder of the collar 24. The collar lip 32 extends completely around the collar 24.

Once the spray mechanism 12 has been screwed on to the bottle portion 10, a cap guard 34 slides over the pump 22 and collar 24 and attaches to the collar 24 in a freely rotatable manner. FIG. 6 shows a cross-section of one embodiment of the cap guard 34. The bottom end 36 of the cap guard 34 is completely open. The top end 38 of the cap guard 24 is provided with a hole 40. An interior lip 42 extends around the interior surface of the cap guard 34 at the bottom end 36. In a preferred embodiment of the cap guard 24, the inner surface of the interior lip 42 is rounded.

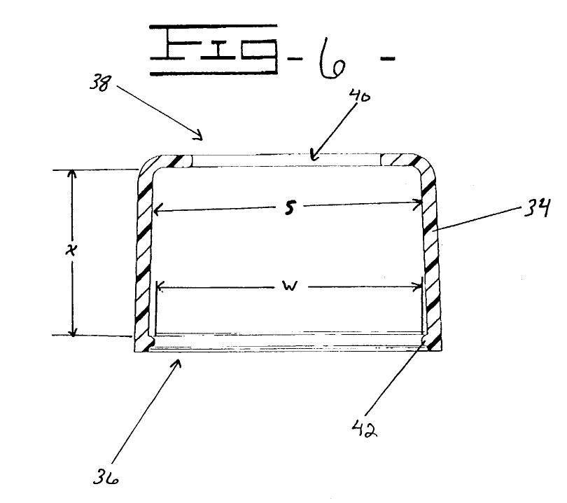

The interaction of the collar 24 and the cap guard 34 is shown in detail in FIG. 5. The interior diameter s of the cap guard 34, except for interior lip 42, is greater than the outside diameter t of the collar 24, including the collar lip 32. The hole 40 is provided with a sufficient diameter to pass over the pump 22, but not the collar 24. In a preferred embodiment of the cap guard 34, the hole 40 is of sufficient diameter to pass over the pump 22 and the cap 26 without being able to pass over the collar 24. As FIG. 5 illustrates, the interior height x of the cap guard 34, measured from the interior surface of the top end 38 to the top of the interior lip 42 is greater than the overall exterior height y of the collar 24, measured from the top surface of the collar 24 to the bottom surface of the collar lip 32. Further, the inner diameter w defined by the interior lip 42 is less than the outer diameter v of the collar lip 32. In a particularly advantageous embodiment, one or both of the collar 24 and the cap guard 34 are made of a relatively rigid molded material that allows the parts to be slightly deformed when a force is exerted on the parts and return to their original shape when the force is removed.

The above-described arrangement allows the cap guard 34 to slide over the pump 22 and around the collar 24. As the cap guard 34 is lowered over the collar 24, the bottom of the interior lip 42 comes into contact with the top of the collar lip 32. The interaction of the collar lip 32 and the interior lip 42 forms a locking mechanism. When a sufficient downward directed force is applied to the cap guard 34, both the cap guard 34 and the collar 24 are deformed sufficiently to permit the interior lip 42 to pass around the collar lip 32. At this point, the cap guard 34 is effectively locked around the collar 24, thereby minimizing or preventing any up or down movement of the cap guard 34 relative to the collar 24 without the exertion of a sufficiently large upward force on the cap guard 34 to deform the parts and permit the interior lip 42 to pass back over the collar lip 32. The material chosen for the manufacture of the cap guard 34 and the collar 24 should be sufficiently rigid to require a force beyond the capacity of young children in order to lift the cap guard 34 off of the collar 24. In a further embodiment, the outside lateral surfaces of the cap guard 34 are provided with a relatively smooth finish in order to make gripping the cap guard 34, and thereby removing it from the collar 24, more difficult.

While the cap guard 34 is in this position, a user cannot directly grip the ribbed surface of the collar 24. In addition, sufficient clearances between the interior height x of the cap guard 34 and the overall exterior height y of the collar 24 and between the interior diameter s of the cap guard 34 and the outside diameter t of the collar 24 are maintained to allow the cap guard 34 to rotate freely about the collar 24. This free rotation combined with the user's inability to directly grip the ribbed surface of the collar 24, severely limit any user's ability to turn the collar 24 in an effort to unscrew and separate the spray mechanism 12 from the bottle portion 10. The rigidity of the collar and 24 and the cap guard 34 require a force beyond the capacity of young children, and some adults, in order to remove the cap guard 34 from the collar 24.

While the cap guard has been described to this point in connection with spray bottles, it may also be adapted for use with other packaging formats in which a bottle or similar package is closed with a cylindrical screw cap. In such an embodiment, the cap guard does not possess a hole in its top surface. However, the remaining structure of the cap guard remains identical to that described above, including the presence of an interior lip. The cylindrical screw cap is likewise arranged in a similar manner to the collar described above without a pump emanating from the top thereof. Like the collar described above, the cylindrical screw cap is provided with an exterior lip at its bottom. The cap guard and cylindrical screw cap operate identically to the cap guard and collar described above.

In yet another application, the cap guard may be utilized to decrease the likelihood that a consumer will remove the screw cap of a screw top container in order to refill the container. This application is frequently encountered in the food packaging industry where one-time use of product packaging is often desirable. In such an application, the cap guard and collar may be manufactured from a material having a higher level of rigidity, resulting in an increase of the amount of force necessary to remove the cap guard from the collar beyond the capacity of most consumers. Limiting the consumer's ability to remove the cap guard greatly reduces the chances that a consumer will be able to open and refill the container.

Other objects, features and advantages of the present invention will be apparent to those skilled in the art. While preferred embodiments of the present invention have been illustrated and described, this has been by way of illustration and the invention should not be limited.

What is claimed is:

1. A packaging guard for a screw top container, including:
a screw cap closing the screw top container and having a collar lip with an outside diameter v extending from a bottom portion of an exterior of the screw cap;
a cap guard with an inside diameter s larger than the outside diameter v of the collar lip and having an interior lip with an inside diameter w smaller than the outside diameter v of the collar lip; and
wherein the interior lip of the cap guard engages the collar lip when the cap guard is placed substantially over the screw cap, thereby securing the cap guard in a position over the screw cap in which the exterior of the screw cap is substantially covered.

2. A packaging guard as set forth in claim 1, wherein the screw top container is a spray bottle and the screw cap includes a collar with a pump mechanism extending from the collar and wherein the cap guard defines an opening in a top surface of the cap guard to provide clearance for the pump mechanism when the cap guard is placed over the collar.

3. A packaging guard as set forth in claim 1, wherein the exterior of the screw cap includes a series of ribs.

4. A packaging guard as set forth in claim 1, wherein the cap guard includes a smooth exterior.

5. A packaging guard as set forth in claim 1, wherein the screw cap has an exterior height y and wherein the cap guard has an interior height x larger than the exterior height y of the screw cap.

6. A packaging guard as set forth in claim 5, wherein the interior height x of the cap guard is measured from a top surface of the interior of the cap guard to the interior lip of the cap guard.

7. A packaging guard as set forth in claim 6, including a first clearance between the interior height x of the cap guard and the exterior height y of the screw cap and a second clearance between the inside diameter s of the cap guard and the outside diameter v of the collar lip and wherein the first and second clearances are sufficient to allow rotation of the cap guard over the screw cap.

8. In a spray bottle having a spray mechanism attached to a bottle by a collar, a packaging guard, including:
a collar lip with an outside diameter v extending from a bottom portion of an exterior of the collar;
a cap guard with an inside diameter s larger than the outside diameter v of the collar lip and having an interior lip with an inside diameter w smaller than the outside diameter v of the collar lip; and
wherein the interior lip of the cap guard engages the collar lip when the cap guard is placed substantially over the collar to secure the cap guard in a position over the collar in which the exterior of the collar is substantially covered.

9. A packaging guard for a spray bottle as set forth in claim 8, wherein the exterior of the collar includes a series of ribs.

10. A packaging guard for a spray bottle as set forth in claim 8, wherein the cap guard includes a smooth exterior.

11. A packaging guard for a spray bottle as set forth in claim 8, wherein the collar has an exterior height y and wherein the cap guard has an interior height x larger than the exterior height y of the collar.

12. A packaging guard for a spray bottle as set forth in claim 11, wherein the interior height x of the cap guard is measured from a top surface of the interior of the cap guard to the interior lip of the cap guard.

13. A packaging guard for a spray bottle as set forth in claim 12, including a first clearance between the interior height x of the cap guard and the exterior height y of the collar and a second clearance between the inside diameter s of the cap guard and the outside diameter v of the collar lip and wherein the first and second clearances are sufficient to allow rotation of the cap guard over the collar.

14. A packaging guard for a spray bottle as set forth in claim 8, wherein the cap guard defines an opening in a top surface of the cap guard to provide clearance for the spray mechanism when the cap guard is placed over the collar.

15. A cap guard for a screw top container having a screw cap, including a cap guard with an inside diameter s and having an interior lip with an inside diameter w;
a collar lip on the screw cap with an outside diameter v; and
wherein the inside diameter s of the cap guard is larger than the outside diameter v of the collar lip and the inside diameter w of the interior lip is smaller than the outside diameter v.

16. A cap guard as set forth in claim 15, wherein the cap guard includes a smooth exterior.

17. A cap guard as set forth in claim 15, wherein the cap guard has an interior height x larger and the screw cap has an exterior height y of the screw cap and wherein the interior height x is larger than the exterior height y.

18. A cap guard as set forth in claim 17, wherein the interior height x of the cap guard is measured from a top surface of the interior of the cap guard to the interior lip of the cap guard.

19. A cap guard as set forth in claim 18, including a first clearance between the interior height x of the cap guard and the exterior height y of the screw cap and a second clearance between the inside diameter s of the cap guard and the outside diameter v of the collar lip and wherein the first and second clearances are sufficient to allow rotation of the cap guard over the screw cap.

20. A method of limiting access to the interior of a screw top container, including the steps of:
closing the screw top container with a screw cap having a collar lip with an outside diameter v extending from a bottom portion of an exterior of the screw cap;
providing a cap guard with an inside diameter s larger than the outside diameter v of the collar lip and having an interior lip with an inside diameter w smaller than the outside diameter v of the collar lip;
sliding the cap guard over the screw cap; and
engaging the interior lip of the cap guard with the collar lip of the screw cap thereby securing the cap guard in a position over the screw cap in which the exterior of the screw cap is substantially covered.

21. A method of rendering a screw top container non-refillable, including the steps of:
closing the screw top container with a screw cap having a collar lip with an outside diameter v extending from a bottom portion of an exterior of the screw cap;
providing a cap guard with an inside diameter s larger than the outside diameter v of the collar lip and having an interior lip with an inside diameter w smaller than the outside diameter v of the collar lip;
sliding the cap guard over the screw cap; and
engaging the interior lip of the cap guard with the collar lip of the screw cap, thereby securing the cap guard in a position over the screw cap in which the exterior of the screw cap is substantially covered.
